(19) United States
(12) Patent Application Publication
(10) Pub. No.: US 2007/0054119 A1
(43) Pub. Date: Mar. 8, 2007

(54) Systems and methods of forming particles

(76) Inventors: Piotr Garstecki, Brwinow (PL); Douglas B. Weibel, Arlington, MA (US); Irina Gitlin, Brookline, MA (US); Shoji Takeuchi, Tokyo (JP); Shengqing Xu, Troy, NY (US); Zhihong Nie, Toronto (CA); Min Seok Seo, Toronto (CA); Patrick C. Lewis, Toronto (CA); Eugenia Kumacheva, Toronto (CA); Howard A. Stone, Brookline, MA (US); George M. Whitesides, Newton, MA (US)

Correspondence Address: WOLF GREENFIELD & SACKS, PC, FEDERAL RESERVE PLAZA, 600 ATLANTIC AVENUE, BOSTON, MA, 02210-2206, US

(21) Appl. No.: 11/368,263

(22) Filed: Mar. 3, 2006

Related U.S. Application Data
(60) Provisional application No. 60/659,046, filed on Mar. 4, 2005.

(51) Int. Cl. B32B 1/00

(52) U.S. Cl. 428/402

(57) ABSTRACT

The present invention generally relates to systems and methods of forming particles and, in certain aspects, to systems and methods of forming particles that are substantially monodisperse. Microfluidic systems and techniques for forming such particles are provided, for instance, particles may be formed using gellation, solidification, and/or chemical reactions such as cross-linking, polymerization, and/or interfacial polymerization reactions. In one aspect, the present invention is directed to a plurality of particles having an average dimension of less than about 500 micrometers and a distribution of dimensions such that no more than about 5% of the particles have a dimension greater than about 10% of the average dimension, which can be made via microfluidic systems. In one set of embodiments, at least some of the particles may comprise a metal, and in certain embodiments, at least some of the particles may comprise a magnetizable material. In another set of embodiments, at least some of the particles may be porous. In some embodiments, the invention includes non-spherical particles. Non-spherical particles may be formed, for example, by urging a fluidic droplet into a channel having a smallest dimension that is smaller than the diameter of a perfect mathematical sphere having a volume of the droplet, and solidifying the droplet, and/or by exposing at least a portion of a plurality of particles to an agent able to remove at least a portion of the particles.

### RELATED APPLICATIONS

This application claims the benefit of U.S. Provisional Patent Application Ser. No. 60/659,046, filed Mar. 4, 2005, entitled “Systems and Methods of Forming Particles,” by Garstecki, et al., which is incorporated herein by reference.

### FEDERALLY SPONSORED RESEARCH

Various aspects of the present invention were sponsored by the NIH, Grant Nos. GM65364 and GM067445, the Department of Energy, Grant No. DE-FG02-OOER45852, DARPA, and the NSF, Grant Nos. DMR-9809363 and DMR-0213805. The U.S. Government may have certain rights in the invention.

### FIELD OF INVENTION

The present invention generally relates to systems and methods of forming particles and, in certain aspects, to systems and methods of forming particles that are substantially monodisperse. In some cases, the present invention generally relates to methods for producing particles having a predetermined shape, size, and/or composition, and in some instances, the present invention relates to a microfluidic reactor able to produce the same.

### BACKGROUND

The manipulation of fluids to form fluid streams of desired configuration, discontinuous fluid streams, dispersions, etc., for purposes of fluid delivery, product manufacture, analysis, and the like, is a relatively well-studied art. For example, highly monodisperse gas bubbles, less than 100 micrometers in diameter, have been produced using a technique referred to as capillary flow focusing. In this technique, gas is forced out of a capillary tube into a bath of liquid, the tube is positioned above a small orifice, and the contraction of flow of the external liquid through this orifice focuses the gas into a thin jet which subsequently breaks into bubbles via capillary instability. In a related technique, a similar arrangement can be used to produce liquid droplets in air.

Microfluidics is an area of technology involving the control of fluid flow at a very small scale. Microfluidic devices typically include very small channels, within which fluid flows, which can be branched or otherwise arranged to allow fluids to be combined with each other, to divert fluids to different locations, to cause laminar flow between fluids, to dilute fluids, or the like. Significant effort has been directed toward “lab-on-a-chip” microfluidic technology, in which researchers seek to carry out known chemical or biological reactions on a very small scale on a “chip,” or a microfluidic device. Additionally, new techniques, not necessarily known on the macro scale, are being developed using microfluidics. Examples of techniques being investigated or developed at the microfluidic scale include high-throughput screening, drug delivery, chemical kinetics measurements, combinatorial chemistry (where rapid testing of chemical reactions, chemical affinity, or microstructure formation are desired), as well as the study of fundamental questions in the fields of physics, chemistry, and engineering. Microfluidics also show promising applications in fields such as combinatorial chemistry or the rapid screening of catalysts. Rapid mass transfer may lead to enhanced efficiency of existing chemical reactions, and may allow one to explore new reaction pathways that would be difficult in conventional reactors.

The formation of particles can be carried out in equipment including moving parts (e.g., a blender or device similarly designed to break up material), which can be prone to failure and, in many cases, is not suitable for control of very small dispersed phase droplets. Specifically, traditional industrial processes typically involve manufacturing equipment built to operate on size scales generally unsuitable for precise control. Membrane emulsification is one small scale technique using micrometer-sized pores to form emulsions. However, the polydispersity of the dispersed phase can in some cases be limited by the pore sizes of the membrane.

### SUMMARY OF THE INVENTION

The present invention generally relates to systems and methods of forming particles that are substantially monodisperse. The subject matter of the present invention involves, in some cases, interrelated products, alternative solutions to a particular problem, and/or a plurality of different uses of one or more systems and/or articles.

In one aspect of the invention, a collection of articles comprising a plurality of particles is provided. In one set of embodiments, at least some of the particles may comprise a metal. In another set of embodiments, at least some of the particles may comprise a magnetizable material. In still another set of embodiments, at least some of the particles comprises a nylon. The particles, in some cases, have an average dimension of less than about 500 micrometers and a distribution of dimensions such that no more than about 5% of the particles have a dimension greater than about 10% of the average dimension.

In another set of embodiments, at least some of the particles may be non-spherical. At least some of the particles, in certain instances, have a ratio of a largest dimension to a smallest dimension that is less than about 5. In one embodiment, the particles have an average dimension of less than about 500 micrometers and a distribution of dimensions such that no more than about 5% of the particles have a dimension greater than about 10% of the average dimension.

In yet another set of embodiments, at least some of the particles have a porosity of at least about 0.1. The particles, in certain embodiments, have an average dimension of less than about 500 micrometers and a distribution of dimensions such that no more than about 5% of the particles have a dimension greater than about 10% of the average dimension.

At least some of the particles, according to still another set of embodiments, are microparticles having a core and a shell. In one embodiment, the shell comprises a nylon. In another embodiment, the core comprises a ferrofluid. In yet another embodiment, the shell comprises a semi-permeable portion.

In another set of embodiments, at least some of the particles comprise nylon. In certain instances, the particles have an average dimension of less than about 500 micrometers and a distribution of dimensions such that no more than about 5% of the particles have a dimension greater than about 10% of the average dimension.

In yet another set of embodiments, at least some of the particles comprise a ferrofluid. The particles, according to one embodiment, have an average dimension of less than about 500 micrometers and a distribution of dimensions such that no more than about 5% of the particles have a dimension greater than about 10% of the average dimension.

The invention, according to another aspect, is a method. In one set of embodiments, the method comprises an act of solidifying at least a portion of a plurality of fluidic droplets. In one embodiment, at least some of the fluidic droplets comprise a metal. In another embodiment, at least some of the fluidic droplets comprise a magnetizable material. In yet another embodiment, at least some of the fluidic droplets comprises a ferrofluid. In still another set of embodiments, at least some of the fluidic droplets comprises a semi-permeable portion. In another set of embodiments, at least some of the fluidic droplets comprises a nylon. The fluidic droplets, in certain cases, have an average dimension of less than about 500 micrometers and a distribution of dimensions such that no more than about 5% of the droplets have a dimension greater than about 10% of the average dimension.

The method, according to another set of embodiments, includes an act of solidifying at least a portion of a plurality of fluidic droplets to form non-spherical particles. In certain instances, the particles have an average dimension of less than about 500 micrometers and a distribution of dimensions such that no more than about 5% of the particles have a dimension greater than about 10% of the average dimension.

In yet another set of embodiments, the method includes acts of urging a fluidic droplet into a microfluidic channel having a smallest cross-section dimension that is smaller than the diameter of a perfect mathematical sphere having a volume of the droplet, and solidifying the fluidic droplet within the channel to form a non-spherical particle.

Another set of embodiments of the invention is directed to a method of exposing at least a portion of a plurality of particles to an agent able to remove at least a portion of the particles. The particles, in certain cases, have an average dimension of less than about 500 micrometers and a distribution of dimensions such that no more than about 5% of the particles have a dimension greater than about 10% of the average dimension.

Yet another set of embodiments includes a method including an act of hardening a polymeric material around a sectioned optical fiber.

In another aspect, the present invention is directed to a method of making one or more of the embodiments described herein, for example, a plurality of particles having an average dimension of less than about 500 micrometers and a distribution of dimensions such that no more than about 5% of the particles have a dimension greater than about 10% of the average dimension. In yet another aspect, the present invention is directed to a method of using one or more of the embodiments described herein. In still another aspect, the present invention is directed to a method of promoting one or more of the embodiments described herein.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1F are various schematic diagrams of certain devices according to one embodiment of the invention;

FIGS. 2A-2G are optical microscopy images of certain particles according to another embodiment of the invention;

FIGS. 3A-3D illustrate size distributions in accordance with yet another embodiment of the invention;

FIGS. 4A-4D are photomicrographs of microscale particles according certain embodiments of the invention;

FIGS. 5A-5C illustrate certain microfluidic channels of the invention;

FIGS. 6A-6C illustrate various methods of forming a microfluidic channel, according to another embodiment of the invention;

FIGS. 7A-7D illustrate the production of fluidic droplets, using certain embodiments of the invention; and

FIGS. 8A-8E illustrate certain particles, formed according to various embodiments of the invention.

### DETAILED DESCRIPTION

The present invention generally relates to systems and methods of forming particles and, in certain aspects, to systems and methods of forming particles that are substantially monodisperse. Microfluidic systems and techniques for forming such particles are provided, for instance, particles may be formed using gellation, solidification, and/or chemical reactions such as cross-linking, polymerization, and/or interfacial polymerization reactions. In one aspect, the present invention is directed to a plurality of particles having an average dimension of less than about 500 micrometers and a distribution of dimensions such that no more than about 5% of the particles have a dimension greater than about 10% of the average dimension, which can be made via microfluidic systems. In one set of embodiments, at least some of the particles may comprise a metal, and in certain embodiments, at least some of the particles may comprise a magnetizable material. In another set of embodiments, at least some of the particles may be porous. In some embodiments, the invention includes non-spherical particles. Non-spherical particles may be formed, for example, by urging a fluidic droplet into a channel having a smallest dimension that is smaller than the diameter of a perfect mathematical sphere having a volume of the droplet, and solidifying the droplet, and/or by exposing at least a portion of a plurality of particles to an agent able to remove at least a portion of the particles.

One aspect of the invention relates to systems and methods for producing droplets of fluid surrounded by a liquid, and solidifying the fluidic droplet, or at least a portion thereof, into a solid. These fluids can be selected among essentially any fluids by those of ordinary skill in the art by considering the relationship between the fluids. For example, the fluid and the liquid may be selected to be immiscible within the time frame of the formation of the fluidic droplets. The fluid and the liquid may be essentially immiscible, i.e., immiscible on a time scale of interest (e.g., the time it takes a fluidic droplet to be transported through a particular system or device). In certain cases, as further described below, the droplets may each be substantially the same shape and/or size. The fluidic droplets may also contain other species in some cases, for example, certain molecular species (e.g., monomers, polymers, metals, magnetizable materials, porogens, etc.), cells, particles, other fluids, or the like. In some embodiments, the droplets may be hardened to form a non-spherical shape, as further discussed below.

As used herein, the term “fluid” generally refers to a substance that tends to flow and to conform to the outline of its container, i.e., a liquid, a gas, a viscoelastic fluid, etc. Typically, fluids are materials that are unable to withstand a static shear stress, and when a shear stress is applied, the fluid experiences a continuing and permanent distortion. The fluid may have any suitable viscosity that permits flow. If two or more fluids are present, each fluid may be independently selected among essentially any fluids (liquids, gases, and the like) by those of ordinary skill in the art, by considering the relationship between the fluids. The fluids may each be miscible or immiscible. Where the portions remain liquid for a significant period of time, then the fluids may be chosen to be at least essentially immiscible. Where, after contact and/or formation of solid particles from fluidic droplets hardened by polymerization or the like, the fluids need not be as immiscible. Those of ordinary skill in the art can select suitable miscible or immiscible fluids, using contact angle measurements or the like, to carry out the techniques of the invention.

A “fluidic droplet” or a “droplet,” as used herein, is an isolated portion of a first fluid that is completely surrounded by a second fluid. It is to be noted that a fluidic droplet is not necessarily spherical, but may assume other shapes as well, for example, depending on the external environment, the dimensions of the channel or other container that the fluidic droplet is contained within, etc.

As used herein, a first entity is “surrounded” by a second entity if a closed planar loop can be drawn around the first entity through only the second entity. A first entity is “completely surrounded” if closed loops going through only the second entity can be drawn around the first entity regardless of direction (orientation of the loop). In one embodiment, the first entity is a cell, for example, a cell suspended in media is surrounded by the media. In another embodiment, the first entity is a particle. In yet another embodiment, the first entity is a fluid (i.e., a fluidic droplet). The second entity may also be a fluid in some cases (e.g., as in a suspension, an emulsion, etc.). If both the first entity and the second entity are fluids, the first entity may also be referred to herein as a “discontinuous” fluid or phase, and the second entity surrounding the first entity may be referred to as the “continuous” fluid or phase. For example, a hydrophilic liquid may be suspended in a hydrophobic liquid, a hydrophobic liquid may be suspended in a hydrophilic liquid, a gas bubble may be suspended in a liquid, etc. Typically, a hydrophobic liquid and a hydrophilic liquid are essentially immiscible with respect to each other, where the hydrophilic liquid has a relatively greater affinity to water than does the hydrophobic liquid. Examples of hydrophilic liquids include, but are not limited to, water and other aqueous solutions comprising water, such as cell or biological media, salt solutions, etc., as well as other hydrophilic liquids such as ethanol. Examples of hydrophobic liquids include, but are not limited to, oils such as hydrocarbons, silicone oils, mineral oils, fluorocarbon oils, organic solvents etc.

In some embodiments, the fluidic droplets may each be substantially the same shape and/or size (“monodisperse”). For example, the fluidic droplets may have a distribution of dimensions such that no more than about 10% of the fluidic droplets have a dimension greater than about 10% of the average dimension of the fluidic droplets, and in some cases, such that no more than about 8%, about 5%, about 3%, about 1%, about 0.3%, about 0.1%, about 0.03%, or about 0.01% have a dimension greater than about 10% of the average dimension of the fluidic droplets. In some cases, no more than about 5% of the fluidic droplets have a dimension greater than about 5%, about 3%, about 1%, about 0.3%, about 0.1%, about 0.03%, or about 0.01% of the average dimension of the fluidic droplets.

The shape and/or size of the fluidic droplets can be determined, for example, by measuring the average diameter or other characteristic dimension of the droplets. The term “determining,” as used herein, generally refers to the analysis or measurement of a species, for example, quantitatively or qualitatively, and/or the detection of the presence or absence of the species. “Determining” may also refer to the analysis or measurement of an interaction between two or more species, for example, quantitatively or qualitatively, or by detecting the presence or absence of the interaction. Examples of suitable techniques include, but are not limited to, spectroscopy such as infrared, absorption, fluorescence, UV/visible, FTIR (“Fourier Transform Infrared Spectroscopy”), or Raman; gravimetric techniques; ellipsometry; piezoelectric measurements; immunoassays; electrochemical measurements; optical measurements such as optical density measurements; circular dichroism; light scattering measurements such as quasielectric light scattering; polarimetry; refractometry; or turbidity measurements.

The “average diameter” of a plurality or series of droplets (or particles) is the arithmetic average of the average diameters of each of the droplets (or particles). Those of ordinary skill in the art will be able to determine the average diameter (or other characteristic dimension) of a plurality or series of droplets or particles, for example, using laser light scattering, microscopic examination, or other known techniques. The diameter of a droplet (or particle) in a non-spherical droplet, is the mathematically-defined average diameter of the droplet, integrated across the entire surface of the droplet (or particle). The average diameter of a droplet or particle (and/or of a plurality or series of droplets and/or particles) may be, for example, less than about 1 mm, less than about 500 micrometers, less than about 200 micrometers, less than about 100 micrometers, less than about 75 micrometers, less than about 50 micrometers, less than about 40 micrometers, less than about 25 micrometers, less than about 10 micrometers, less than about 5 micrometers, less than about 1 micrometer, less than about 0.3 micrometers, less than about 0.1 micrometers, less than about 0.03 micrometers, or less than about 0.01 micrometers in some cases. The average diameter of the droplet(s) and/or particle(s) may also be at least about 1 micrometer, at least about 2 micrometers, at least about 3 micrometers, at least about 5 micrometers, at least about 10 micrometers, at least about 15 micrometers, or at least about 20 micrometers in certain cases.

In some embodiments of the invention, as mentioned above, the fluidic droplets may contain additional entities, for example, other chemical, biochemical, or biological entities (which may be dissolved or suspended in the fluid in some cases), for example, monomers, polymers, metals, magnetizable materials, porogens, cells, gases, other fluids, or the like. In some cases, the fluidic droplets may each be substantially the same shape and/or size. In certain instances, the invention provides for the production of fluidic droplets consisting essentially of a substantially uniform number of entities of a species therein (i.e., molecules, cells, particles, etc.). For example, about 90%, about 93%, about 95%, about 97%, about 98%, or about 99%, or more of a plurality or series of fluidic droplets may each contain the same number of entities of a particular species. For instance, a substantial number of fluidic droplets produced, e.g., as described herein, may each contain 1 entity, 2 entities, 3 entities, 4 entities, 5 entities, 7 entities, 10 entities, 15 entities, 20 entities, 25 entities, 30 entities, 40 entities, 50 entities, 60 entities, 70 entities, 80 entities, 90 entities, 100 entities, etc., where the entities are molecules or macromolecules, cells, particles, etc. In some cases, the droplets may each independently contain a range of entities, for example, less than 20 entities, less than 15 entities, less than 10 entities, less than 7 entities, less than 5 entities, or less than 3 entities in some cases.

In one set of embodiments, the present invention involves formation of fluidic droplets within a liquid, of controlled size and/or size distribution, in a device (e.g., a microfluidic device) to create drop formation. The device may be free of moving parts in some cases. That is, at the location or locations at which fluidic droplets of desired shape and/or size are formed, the device is free of components that move relative to the device as a whole to affect fluidic droplet formation. For example, where fluidic droplets of controlled shape and/or size are formed, the droplets are formed without parts that move relative to other parts of the device that define a channel within which the fluidic droplets flow. This can be referred to as “passive control” or “passive breakup.”

In one example of a passive system, fluid may be urged through a dimensionally-restricted section of a channel of a fluidic device, which can cause the fluid to break up into a series of droplets within the channel. The dimensionally-restricted section can take any of a varieties of forms. For example, it can be an annular orifice, elongate, ovoid, square, or the like. Preferably, it is shaped in any way that causes the surrounding liquid to surround and constrict the cross-sectional shape of the fluid being surrounded. The dimensionally-restricted section is non-valved in certain embodiments. That is, it is an orifice that cannot be switched between an open state and a closed state, and typically is of fixed size. One or more intermediate fluid channels can also be provided in some cases to provide an encapsulating fluid surrounding discontinuous portions of fluid being surrounded. Thus, in one embodiment, two intermediate fluid channels are provided, one on each side of a central fluid channel, each with an outlet near the central fluid channel. Control of the fluid flow rate, and ratio between the flow rates of the various fluids within the device, can be used to control the shape and/or size of the fluidic droplets, and/or the monodispersity of the fluidic droplets. The microfluidic devices of the present invention, coupled with the flow rate and ratio control as taught herein, thus may allow significantly improved control and range.

Certain embodiments of the present invention relate to systems and methods for forming microfluidic channels having one or more dimensionally-restricted sections. One set of embodiments relates to microfluidic channels formed by creating a mold using a wire, a cable, and/or a fiber, forming a polymer or other substrate around the mold, then removing the mold, thus creating a space within the polymer or other substrate that defines the microfluidic channel. The wire, cable and/or fiber may be sized in such a manner as to create a dimensionally-restricted sections when removed. For example, hollow fibers may be positioned around another wire, a cable, and/or a fiber, as is shown in FIG. 11C, to create the dimensionally-restricted sections when the wires/cables/fibers are removed. As another example, a wire, a cable, and/or a fiber may be sectioned or partially sectioned to form a template or mold for a microfluidic article. “Sectioned,” as used herein, means that the article, in its normal form as intended for is primary use (e.g. an optical fiber, for the transmission of light) has had at least one portion removed (e.g., a concentric portion surrounding the center of the wire, cable, and/or fiber), such that, upon removal of the wire, cable, and/or fiber, a dimensionally-restricted section is formed. As a non-limiting example, in FIG. 11A, a fiber is prepared by partially sectioning the fiber, revealing a portion having a smaller dimension than the remainder of the fiber; the fiber is then used as a mold or template to form a microfluidic channels having a dimensionally-restricted section. Other examples of systems and methods for forming microfluidic channels having one or more dimensionally-restricted sections can be found in International Patent Application Serial No. PCT/US03/20542, filed Jun. 30, 2003 by Stone, et al., published as WO 2004/002627 on Jan. 8, 2004, incorporated herein by reference.

Some embodiments of the present invention involve formation of fluidic droplets in a liquid where the fluidic droplets have a mean cross-sectional dimension no smaller than the mean cross-sectional dimension of the dimensionally-restricted section. The invention, in such embodiments, may involve control over these mean cross-sectional dimensions by control of the flow rate of the fluid, liquid, or both, and/or control of the ratios of these flow rates. In other embodiments, the fluidic droplets have a mean cross-sectional dimension no smaller than about 90% of the mean cross-sectional dimension of the dimensionally-restricted section, and in still other embodiments, no smaller than about 80%, about 70%, about 60%, about 50%, about 40%, or about 30% of the mean cross-sectional dimension of the dimensionally-restricted section.

In another set of embodiments, droplets of fluid can be created in a channel from a fluid surrounded by a liquid, by altering the channel dimensions in a manner that is able to induce the fluid to form individual droplets. The channel may, for example, be a channel that expands relative to the direction of flow, e.g., such that the fluid does not adhere to the channel walls and forms individual droplets instead, or a channel that narrows relative to the direction of flow, e.g., such that the fluid is forced to coalesce into individual droplets. In some embodiments, internal obstructions may also be used to cause droplet formation to occur. For instance, baffles, ridges, posts, or the like may be used to disrupt liquid flow in a manner that causes the fluid to coalesce into fluidic droplets. In some cases, the channel dimensions may be altered with respect to time (for example, mechanically, electromechanically, pneumatically, etc.) in such a manner as to cause the formation of individual fluidic droplets to occur. For example, the channel may be mechanically contracted (“squeezed”) to cause droplet formation, or a fluid stream may be mechanically disrupted to cause droplet formation, for example, through the use of moving baffles, rotating blades, or the like.

Other techniques of producing droplets of fluid surrounded by a liquid are described in International Patent Application No. PCT/US03/20542, filed Jun. 30, 2003, entitled “Method and Apparatus for Fluid Dispersion,” by Stone, et al., published as WO 2004/002627 on Jan. 8, 2004; and International Patent Application No. PCT/US2004/027912, filed Aug. 27, 2004, entitled “Electronic Control of Fluidic Species,” by Link, et al., each incorporated herein by reference. For example, in some embodiments, an electric charge may be created on a fluid surrounded by a liquid, which may cause the fluid to separate into individual droplets within the liquid.

In some embodiments, the fluidic droplets may be solidified to form solid particles. Any technique able to solidify a fluidic droplet into a solid particle can be used. For example, a fluidic droplet may be cooled to a temperature below the melting point or glass transition temperature of a fluid within the fluidic droplet, a chemical reaction may be induced that causes the fluidic droplet to solidify (for example, a polymerization reaction, a reaction between two fluids that produces a solid product, etc.), or the like.

In one embodiment, the fluidic droplet is solidified by reducing the temperature of the fluidic droplet to a temperature that causes at least one of the components of the fluidic droplet to reach a solid state. For example, the fluidic droplet may be solidified by cooling the fluidic droplet to a temperature that is below the melting point or glass transition temperature of a component of the fluidic droplet, thereby causing the fluidic droplet to become solid. As non-limiting examples, the fluidic droplet may be formed at an elevated temperature (i.e., above room temperature, about 25° C.), then cooled, e.g., to room temperature or to a temperature below room temperature; the fluidic droplet may be formed at room temperature, then cooled to a temperature below room temperature, or the like.

As a particular example, the fluidic droplet may comprise a metal, such as solder, that is solid at room temperatures, but is liquid at easily accessible elevated temperatures (i.e., a “low melting point” metal, that is, the fluidic droplet may comprise a metal that can be melted at a temperature that is less than the temperature at which a component of the fluidic device containing the metal melts or otherwise becomes permanently deformed.). Note that, as used herein, the term “metal” may also include metal alloys. For instance, the metal of the fluidic droplet may have a melting point less than about 900° C., less than about 800° C., less than about 700° C., less than about 600° C., less than about 500° C., less than about 400° C., less than about 300° C., less than about 200° C., or less than about 100° C. in some cases. The melting point of the metal may be greater than room temperature, or less than room temperature in certain instances. The metal may be chosen by those of ordinary skill in the art to have a suitable melting temperature that allows the fabrication of particles from fluidic droplets within the fluidic device, for example, with a knowledge of melting points, eutectic properties, etc. of the metal and/or components of the metal.

As non-limiting examples, the metal may be, or include, solder, gallium, bismuth, or the like. Examples of solder include, but are not limited to, solders including various alloys of tin and lead, for example, 40% Sn/60% Pb, 50% Sn/50% Pb, 60% Sn/40% Pb, etc. Other solders may include other metals in addition to tin and/or lead, for example, bismuth, cadmium, tin, indium, zinc, antimony, copper, silver, gold, etc. Specific non-limiting examples of solder include 45% Bi/23% Pb/8% Sn/5% Cd/19% In (melting point of about 47° C.), 50% Bi/25% Pb/12.5% Sn/12.5% Cd (melting point of about 70° C.), 48% Sn/52% In (melting point of about 118° C.), 42% Sn/58% Bi (melting point of about 138° C.), 63% Sn/37% Pb (melting point of about 183° C.), 91% Sn/9% Zn (melting point of about 199° C.), 93.5% Sn/3% Sb/2% Bi/1.5% Cu (melting point of about 218° C.), 95.5% Sn/3.5% Ag/1% Zn (melting point of about 218° C. to about 221° C.), 99.3% Sn/0.7% Cu (melting point of about 227° C.), 95% Sn/5% Sb (melting point of about 232° C.-240° C.), 65% Sn/25% Ag/10% Sb (melting point of about 233° C.), 97% Sn/2% Cu/0.8% Sb/0.2% Ag (melting point of about 226° C.-228° C.), 77.2% Sn/20% In/2.8% Ag (melting point of about 187° C.), 84.5% Sn/7.5% Bi/5% Cu/2% Ag (melting point of about 212° C.), 81% Sn/9% Zn/10% In (melting point of about 178° C.), 96.2% Sn/2.5% Ag/0.8% Cu/0.5% Sb (melting point of about 215° C.), or 93.6% Sn/4.7% Ag/1.7% Cu (melting point of about 217° C.).

As another non-limiting example of a low melting point metal, low melting temperature bismuth alloys may be used in some cases, for example, bismuth alloys that contain about 20% to 25% lead and about 10% cadmium. Yet another non-limiting example of a low melting point metal is Wood's Metal.

In another embodiment, the fluidic droplet is solidified using a chemical reaction that causes solidification of a fluid to occur. For example, two or more fluids added to a fluidic droplet may react to produce a solid product, thereby causing formation of a solid particle. As another example, a first reactant within the fluidic droplet may be reacted with a second reactant within the liquid surrounding the fluidic droplet to produce a solid, which may thus coat the fluidic droplet within a solid “shell” in some cases, thereby forming a core/shell particle having a solid shell or exterior, and a fluidic core or interior. As yet another example, a polymerization reaction may be initiated within a fluidic droplet, thereby causing the formation of a polymeric particle. For instance, the fluidic droplet may contain one or more monomer or oligomer precursors (e.g., dissolved and/or suspended within the fluidic droplet), which may polymerize to form a polymer that is solid. The polymerization reaction may occur spontaneously, or be initiated in some fashion, e.g., during formation of the fluidic droplet, or after the fluidic droplet has been formed. For instance, the polymerization reaction may be initiated by adding an initiator to the fluidic droplet, by applying light or other electromagnetic energy to the fluidic droplet (e.g., to initiate a photopolymerization reaction), or the like.

A non-limiting example of a solidification reaction is a polymerization reaction involving production of a nylon (e.g., a polyamide), for example, from a diacid chloride and a diamine. Those of ordinary skill in the art will know of various suitable nylon-production techniques. For example, nylon-6,6 may be produced by reacting adipoyl chloride and 1,6-diaminohexane. For instance, a fluidic droplet may be solidified by reacting adipoyl chloride in the continuous phase with 1,6-diaminohexane within the fluidic droplet, which can react to form nylon-6,6 at the surface of the fluidic droplet. Depending on the reaction conditions, nylon-6,6 may be produced at the surface of the fluidic droplet (forming a particle having a solid exterior and a fluidic interior), or within the fluidic droplet (forming a solid particle).

As previously described, in one set of embodiments, fluidic droplets having a solid exterior and a fluidic interior are produced. In some cases, the solid exterior may comprise a polymer, and in certain embodiments, the polymer may form a semipermeable membrane surrounding the fluidic interior of the particle. The semipermeable membrane may allow water transport to occur therethrough, but prevent or at least inhibit transport of salts and/or ions therethrough. In some instances, by exposing the particles to surrounding liquids having higher or lower osmolarities (or salt or ion concentrations), the size and/or shape of the particle may be decrease or increase due to osmotic pressure differences between the surrounding liquid and the fluidic interior of the particle. In some cases, the particles, upon swelling or shrinkage, may adopt a non-spherical configuration.

In some cases, the fluidic droplet may comprise a material having a sol state and a gel state, such that the conversion of the material from the sol state into a gel state causes the fluidic droplet to solidify. The conversion of the sol state of the material within the fluidic droplet into a gel state may be accomplished through any technique known to those of ordinary skill in the art, for instance, by cooling the fluidic droplet, by initiating a polymeric reaction within the droplet, etc. For example, if the material includes agarose, the fluidic droplet containing the agarose may be produced at a temperature above the gelling temperature of agarose, then subsequently cooled, causing the agarose to enter a gel state. As another example, if the fluidic droplet contains acrylamide (e.g., dissolved within the fluidic droplet), the acrylamide may be polymerized (e.g., using tetramethylethylenediamine) to produce a polymeric particle comprising polyacrylamide.

Certain embodiments of the invention are directed to the production of particles having substantially the same shape and/or size, as previously mentioned. For instance, in some embodiments, fluidic droplets having substantially the same shape and/or size are solidified into particles that also each have substantially the same shape and/or size. For example, the particles may have a distribution of dimensions such that no more than about 5% of the particles have a dimension greater than about 10% of the average dimension of the particles, and in some cases, such that no more than about 3%, about 1%, about 0.3%, about 0.1%, about 0.03%, or about 0.01% have a dimension greater than about 10% of the average dimension of the particles. In some cases, no more than about 5% of the particles have a dimension greater than about 5%, about 3%, about 1%, about 0.3%, about 0.1%, about 0.03%, or about 0.01% of the average dimension of the particles, depending on the particular application.

Another aspect of the invention is generally directed to particles that comprise a metal (including metal alloys) and/or a magnetizable material, for instance, solid metal particles. In some embodiments, the particle may be formed of a metal, or the particle may contain one or more metals and/or magnetizable materials therein. As an example, the particle may be a polymer comprising a metal and/or a magnetizable material, for instance, physically admixed within the polymer, or chemically combined with the polymer. Examples of metals that may be included within the particle include, but are not limited to, lead, bismuth, cadmium, tin, indium, zinc, antimony, copper, silver, gold, iron, or the like. In some embodiments, one or more metals and/or magnetizable materials may be introduced into a particle by introducing a metal into a fluidic droplet before solidifying the fluidic droplet to form the particle. In certain cases, the fluidic droplet itself may be a fluidic metal droplet, for example, a fluidic droplet formed of a metal that is liquid at easily accessible elevated temperatures, as previously described.

As used herein, a “magnetizable material” is a material that is susceptible to the presence of magnetic field, and in some cases, can be manipulated using an externally applied magnetic field. The magnetizable material may be paramagnetic, or ferromagnetic in some cases. In certain embodiments, the particle may include sufficient magnetizable material such that the particles can be moved or otherwise directed through the use of suitable magnetic fields, for example, created by permanent magnets, electromagnets, or the like. In some cases, the magnetizable material includes a magnetizable metal, for example, iron, nickel, or cobalt, or a magnetizable alloy such as neodymium-iron-boron, strontium ferrite, alnico, etc.

In one set of embodiments, the magnetizable material may be, or include, a ferrofluid, i.e., a fluid that is attracted to a magnet. In one embodiment, the ferrofluid comprises nanoparticles (for example, of iron oxide or magnetite), having average diameters of approximately 100 nm, approximately 50 nm, approximately 10 nm, etc., which may be a colloidal suspension. As an example, a ferrofluid may include 5% or 10% nanoparticles (by volume) in a carrier fluid. The ferrofluid optionally can include a surfactant, e.g., to prevent particle agglomeration. In some cases, the particles comprising the ferrofluid may be manipulated as described above, e.g., using an externally applied magnetic field.

Yet another aspect of the present invention is generally directed to removing portions of a particle. Various portions or sections of a particle may be removed after formation of the particle (e.g., as previously described), for example, physically and/or chemically removed. In some cases, portions of the particle may be removed to produce a porous particle, for example, using a porogen, as further discussed below.

In one set of embodiments, the particle may comprise a first composition and a second composition, and the particle may be exposed to an agent that is able to remove the first composition but is not able to substantially remove the second composition. The first and second compositions may be homogeneously or heterogeneously distributed within the particle. As an example, the first composition may dissolve in the agent relatively quickly, but the second composition may dissolve in the agent relatively slowly, or the second composition may be insoluble in the agent.

In some embodiments, where the first composition and the second composition are substantially homogeneously dispersed within the particle, relatively greater removal of the first composition, relative to the second composition, may result in a particle having pores, i.e., a porous particle. In such cases, the first composition may also be referred to as a “porogen.” Depending on the application, the exact porosity of the porous particle may be controlled, for instance, by controlling the concentration of the porogen in the particle by selection of the agent, and/or by controlling the exposure of the particle to the agent able to dissolve the porogen. For example, the particle may have a porosity of at least about 0.1, at least about 0.2, at least about 0.3, at least about 0.4, or more in some cases.

As a specific example, a particle may be prepared (e.g., as previously described, or using any other suitable technique) that includes a polymer, such as a polyacrylate, a polymethacrylate, a polysiloxane, etc, and a porogen, such as dioctyl pathalate, that is readily dissolvable in an organic solvent, such as acetone, or other organic solvents as previously described. The polymeric particle containing the polymer and the porogen is then exposed to the organic solvent, which removes a greater amount of the porogen, relative to the polymer, thereby forming a porous particle. An example of a porous particle can be seen in FIG. 4D.

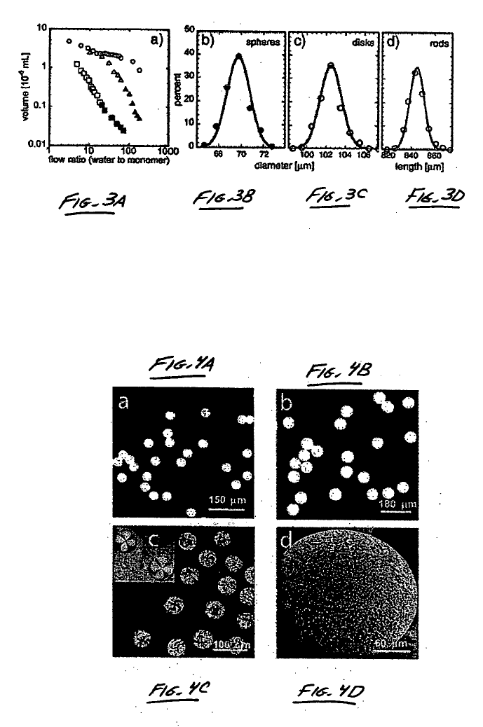

Still another aspect of the present invention is generally directed to non-spherical particles. As used herein, a “non-spherical particle” is a particle having dimensions such that, when imaged (for example, using light or electron microscopy), the particle can be characterized as having a visibly non-spherical shape. Examples of non-spherical particles include, but are not limited to, rods, discs, or ellipsoids. Non-limiting examples of images of non-spherical particles are shown in FIGS. 2C (rods), and 2D and 2E (ellipsoids). In some, but not all, embodiments, the non-spherical particle may have an aspect ratio (ratio of the largest dimension of the particle that passes through the center of the particle, with respect to the smallest dimension of the particle that passes through the center of the particle) of at least about 1.3:1, and in certain instances, the aspect ratio may be at least about 1.5:1, at least about 2:1, at least about 3:1, at least about 4:1, at least about 5:1, at least about 7:1, at least about 10:1, at least about 12:1, at least about 15:1, at least about 20:1, or more in some cases.

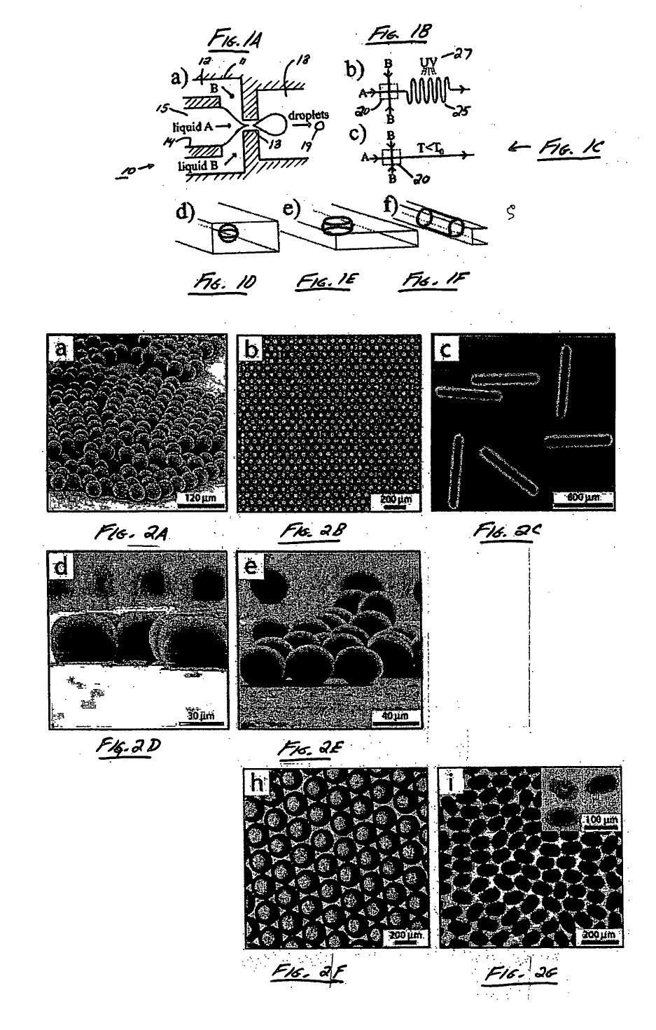

In one set of embodiments, non-spherical particles can be created using any of the systems and methods described herein. In another set of embodiments, a non-spherical particle may be created by urging a fluidic droplet into a channel having a smallest cross-sectional dimension (i.e., in a direction perpendicular to fluid flow within the channel) that is smaller than the diameter of a perfect mathematical sphere having a volume of the droplet, then solidifying the fluidic droplet while it is still contained within the channel. As the fluidic droplet cannot form a spherical shape within the channel due to the size of the channel, the fluidic droplet will consequently be distorted, thereby forming a non-spherical droplet within the channel. The non-spherical droplet can then be solidified to form a non-spherical particle. In one example, shown in FIG. 1E, a fluidic droplet contained within a channel having a smallest dimension that is smaller than the diameter of a perfect mathematical sphere having a volume of the fluidic droplet may be “squashed” to form a disc shape and or an ellipsoid shape. As another example, a fluidic droplet contained within a channel may be sufficiently large that the fluidic droplet may be extended within the channel, thereby forming a rod-like shape, e.g., as in shown in FIG. 1F.

Yet another aspect of the invention is generally directed to particles having a relatively high surface-to-volume ratio. Examples include particles such as those previously described. In one set of embodiments, a particle may have a surface-to-volume ratio of at least about 6.5/d, where d is the mathematically-defined average diameter of the particle, integrated across the entire surface. In other embodiments, the surface-to-volume ratio may be at least about 7/d, at least about 7.5/d, at least about 8/d, at least about 9/d, at least about 10/d, at least about 12/d, at least about 15/d, at least about 20/d, at least about 50/d, or more in some cases. (It should be noted that the surface-to-volume ratio of a particle is not dimensionless, but has units of inverse length, being an area divided by a volume.) In certain embodiments, a particle having a relatively high surface-to-volume ratio is non-spherical, e.g., non-spherical particles such as those previously described. In another set of embodiments, the particle is porous, for instance, produced using the systems and methods previously described, and the porous particle may be spherical or non-spherical. Due to the porosity of the particle, the particle may have a high exposed surface area relative to its volume, in comparison with smooth, non-porous particles.

As mentioned above, some, but not all, aspects of the invention are directed to devices including one or more microfluidic components, for example, one or more microfluidic channels, for example, which can be used to produce fluidic droplets and/or particles. “Microfluidic,” as used herein, refers to a device, apparatus, or system including at least one fluidic channel having a cross-sectional dimension of less than about 2 mm, and a ratio of length to largest cross-sectional dimension of the channel of at least 3:1. Thus, “microfluidic channel,” as used herein, is a channel meeting these criteria. The “cross-sectional dimension” of the channel is measured perpendicular to the direction of fluid flow within the channel. In one set of embodiments, all fluidic channels containing embodiments of the invention are microfluidic and/or have a largest cross sectional dimension of no more than 2 mm or 1 mm. In certain embodiments, the fluidic channels may be formed, at least in part, by a single component (e.g. an etched substrate or molded unit). Of course, larger channels, tubes, chambers, reservoirs, etc. can be used to store fluids and/or deliver fluids to various components or systems of the invention. In one set of embodiments, the maximum cross-sectional dimension of the channel(s) containing embodiments of the invention is less than 500 micrometers, less than 200 micrometers, less than 100 micrometers, less than 50 micrometers, or less than 25 micrometers.

A “channel,” as used herein, is a feature on or in an article (substrate) that at least partially directs flow of a fluid. The channel can have any cross-sectional shape (circular, oval, triangular, irregular, square, or rectangular, or the like) and can be covered or uncovered. In embodiments where it is completely covered, at least one portion of the channel can have a cross-section that is completely enclosed, or the entire channel may be completely enclosed along its entire length with the exception of its inlet(s) and/or outlet(s). A channel may also have an aspect ratio (length to average cross sectional dimension) of at least about 2:1, more typically at least about 3:1, about 5:1, about 10:1, about 15:1, about 20:1, or more. An open channel generally will include characteristics that facilitate control over fluid transport, e.g., structural characteristics (an elongated indentation) and/or physical or chemical characteristics (hydrophobicity vs. hydrophilicity) and/or other characteristics that can exert a force (e.g., a containing force) on a fluid. The fluid within the channel may partially or completely fill the channel. In some cases where an open channel is used, the fluid may be held within the channel, for example, using surface tension (i.e., a concave or convex meniscus).

The channel may be of any size, for example, having a largest dimension perpendicular to fluid flow of less than about 5 mm or about 2 mm, or less than about 1 mm, or less than about 500 microns, less than about 200 microns, less than about 100 microns, less than about 60 microns, less than about 50 microns, less than about 40 microns, less than about 30 microns, less than about 25 microns, less than about 10 microns, less than about 3 microns, less than about 1 micron, less than about 300 nm, less than about 100 nm, less than about 30 nm, or less than about 10 nm. In some cases the dimensions of the channel may be chosen such that fluid is able to freely flow through the article or substrate. The dimensions of the channel may also be chosen, for example, to allow a certain volumetric or linear flow rate of fluid in the channel. Of course, the number of channels and the shape of the channels can be varied by any method known to those of ordinary skill in the art. In some cases, more than one channel or capillary may be used. For example, two or more channels may be used, positioned adjacent to each other, positioned to intersect with each other, etc.

A variety of materials and methods, according to certain aspects of the invention, can be used to form any of the above-described components of the systems and devices of the invention. In some cases, the various materials selected lend themselves to various methods. For example, various components of the invention can be formed from solid materials, in which the channels can be formed via micromachining, film deposition processes such as spin coating and chemical vapor deposition, laser fabrication, photolithographic techniques, etching methods including wet chemical or plasma processes, and the like. See, for example, Scientific American, 248:44-55, 1983 (Angell, et al). In one embodiment, at least a portion of the fluidic system is formed of silicon by etching features in a silicon chip. Technologies for precise and efficient fabrication of various fluidic systems and devices of the invention from silicon are known. In another embodiment, various components of the systems and devices of the invention can be formed of a polymer, for example, an elastomeric polymer such as polydimethylsiloxane (“PDMS”), polytetrafluoroethylene (“PTFE” or Teflon®), or the like.

Different components can be fabricated of different materials. For example, a base portion including a bottom wall and side walls can be fabricated from an opaque material such as silicon or PDMS, and a top portion can be fabricated from a transparent or at least partially transparent material, such as glass or a transparent polymer, for observation and/or control of the fluidic process. Components can be coated so as to expose a desired chemical functionality to fluids that contact interior channel walls, where the base supporting material does not have a precise, desired functionality. For example, components can be fabricated as illustrated, with interior channel walls coated with another material. Material used to fabricate various components of the systems and devices of the invention, e.g., materials used to coat interior walls of fluid channels, may desirably be selected from among those materials that will not adversely affect or be affected by fluid flowing through the fluidic system, e.g., material(s) that is chemically inert in the presence of fluids to be used within the device.

In one embodiment, various components of the invention are fabricated from polymeric and/or flexible and/or elastomeric materials, and can be conveniently formed of a hardenable fluid, facilitating fabrication via molding (e.g. replica molding, injection molding, cast molding, etc.). The hardenable fluid can be essentially any fluid that can be induced to solidify, or that spontaneously solidifies, into a solid capable of containing and/or transporting fluids contemplated for use in and with the fluidic network. In one embodiment, the hardenable fluid comprises a polymeric liquid or a liquid polymeric precursor (i.e. a “prepolymer”). Suitable polymeric liquids can include, for example, thermoplastic polymers, thermoset polymers, or mixture of such polymers heated above their melting point. As another example, a suitable polymeric liquid may include a solution of one or more polymers in a suitable solvent, which solution forms a solid polymeric material upon removal of the solvent, for example, by evaporation. Such polymeric materials, which can be solidified from, for example, a melt state or by solvent evaporation, are well known to those of ordinary skill in the art. A variety of polymeric materials, many of which are elastomeric, are suitable, and are also suitable for forming molds or mold masters, for embodiments where one or both of the mold masters is composed of an elastomeric material. A non-limiting list of examples of such polymers includes polymers of the general classes of silicone polymers, epoxy polymers, and acrylate polymers. Epoxy polymers are characterized by the presence of a three-membered cyclic ether group commonly referred to as an epoxy group, 1,2-epoxide, or oxirane. For example, diglycidyl ethers of bisphenol A can be used, in addition to compounds based on aromatic amine, triazine, and cycloaliphatic backbones. Another example includes the well-known Novolac polymers. Non-limiting examples of silicone elastomers suitable for use according to the invention include those formed from precursors including the chlorosilanes such as methylchlorosilanes, ethylchlorosilanes, phenylchlorosilanes, etc.

Silicone polymers are preferred in one set of embodiments, for example, the silicone elastomer polydimethylsiloxane. Non-limiting examples of PDMS polymers include those sold under the trademark Sylgard by Dow Chemical Co., Midland, Mich., and particularly Sylgard 182, Sylgard 184, and Sylgard 186. Silicone polymers including PDMS have several beneficial properties simplifying fabrication of the microfluidic structures of the invention. For instance, such materials are inexpensive, readily available, and can be solidified from a prepolymeric liquid via curing with heat. For example, PDMSs are typically curable by exposure of the prepolymeric liquid to temperatures of about, for example, about 65° C. to about 75° C. for exposure times of, for example, about an hour. Also, silicone polymers, such as PDMS, can be elastomeric, and thus may be useful for forming very small features with relatively high aspect ratios, necessary in certain embodiments of the invention. Flexible (e.g., elastomeric) molds or masters can be advantageous in this regard.

One advantage of forming structures such as microfluidic structures of the invention from silicone polymers, such as PDMS, is the ability of such polymers to be oxidized, for example by exposure to an oxygen-containing plasma such as an air plasma, so that the oxidized structures contain, at their surface, chemical groups capable of cross-linking to other oxidized silicone polymer surfaces or to the oxidized surfaces of a variety of other polymeric and non-polymeric materials. Thus, components can be fabricated and then oxidized and essentially irreversibly sealed to other silicone polymer surfaces, or to the surfaces of other substrates reactive with the oxidized silicone polymer surfaces, without the need for separate adhesives or other sealing means. In most cases, sealing can be completed simply by contacting an oxidized silicone surface to another surface without the need to apply auxiliary pressure to form the seal. That is, the pre-oxidized silicone surface acts as a contact adhesive against suitable mating surfaces. Specifically, in addition to being irreversibly sealable to itself, oxidized silicone such as oxidized PDMS can also be sealed irreversibly to a range of oxidized materials other than itself including, for example, glass, silicon, silicon oxide, quartz, silicon nitride, polyethylene, polystyrene, glassy carbon, and epoxy polymers, which have been oxidized in a similar fashion to the PDMS surface (for example, via exposure to an oxygen-containing plasma). Oxidation and sealing methods useful in the context of the present invention, as well as overall molding techniques, are described in the art, for example, in an article entitled “Rapid Prototyping of Microfluidic Systems and Polydimethylsiloxane,” Anal. Chem., 70:474-480, 1998 (Duffy, et al.), incorporated herein by reference.

In some embodiments, certain microfluidic structures of the invention (or interior, fluid-contacting surfaces) may be formed from certain oxidized silicone polymers. Such surfaces may be more hydrophilic than the surface of an elastomeric polymer. Such hydrophilic channel surfaces can thus be more easily filled and wetted with aqueous solutions.

In one embodiment, a bottom wall of a microfluidic device of the invention is formed of a material different from one or more side walls or a top wall, or other components. For example, the interior surface of a bottom wall can comprise the surface of a silicon wafer or microchip, or other substrate. Other components can, as described above, be sealed to such alternative substrates. Where it is desired to seal a component comprising a silicone polymer (e.g. PDMS) to a substrate (bottom wall) of different material, the substrate may be selected from the group of materials to which oxidized silicone polymer is able to irreversibly seal (e.g., glass, silicon, silicon oxide, quartz, silicon nitride, polyethylene, polystyrene, epoxy polymers, and glassy carbon surfaces which have been oxidized). Alternatively, other sealing techniques can be used, as would be apparent to those of ordinary skill in the art, including, but not limited to, the use of separate adhesives, thermal bonding, solvent bonding, ultrasonic welding, etc.

The following applications are each incorporated herein by reference: U.S. Provisional Patent Application Ser. No. 60/498,091, filed Aug. 27, 2003, by Link, et. al.; U.S. Provisional Patent Application Ser. No. 60/392,195, filed Jun. 28, 2002, by Stone, et. al.; U.S. Provisional Patent Application Ser. No. 60/424,042, filed Nov. 5, 2002, by Link, et al.; U.S. Pat. No. 5,512,131, issued Apr. 30, 1996 to Kumar, et al.; International Patent Publication WO 96/29629, published Jun. 26, 1996 by Whitesides, et al.; U.S. Pat. No. 6,355,198, issued Mar. 12, 2002 to Kim, et al.; International Patent Application Serial No.: PCT/US01/16973, filed May 25, 2001 by Anderson, et al., published as WO 01/89787 on Nov. 29, 2001; International Patent Application Serial No. PCT/US03/20542, filed Jun. 30, 2003 by Stone, et al., published as WO 2004/002627 on Jan. 8, 2004; International Patent Application Serial No. PCT/US2004/010903, filed Apr. 9, 2004 by Link, et al.; U.S. Provisional Patent Application Ser. No. 60/461,954, filed Apr. 10, 2003, by Link, et al.; International Patent Application Serial No. PCT/US2004/027912, filed Aug. 27, 2004, by Link, et al.; U.S. Provisional Patent Application Ser. No. 60/659,045, filed Mar. 4, 2005, by Weitz, et al.; and a PCT patent application, entitled “Method and Apparatus for Forming Multiple Emulsions,” by Link, et al., filed on even date herewith.

The following examples are intended to illustrate certain embodiments of the present invention, but do not exemplify the full scope of the invention.

### EXAMPLE 1

This example illustrates the formation of substantially monodisperse droplets using flow focusing techniques, where at least 90% of the droplets are within 5% of the median size. Dispersities were determined by curve fitting of the experimental histograms of the size of the particles with Gaussian distributions. The standard deviations were typically on the order of 1%-2% of the mean size.

Various microfluidic flow-focusing devices (“MFFD”) were used in this example to generate fluidic droplets, using techniques similar to those described in International Patent Application No. PCT/US03/20542, filed Jun. 30, 2003, entitled “Method and Apparatus for Fluid Dispersion,” by Stone, et al., published as WO 2004/002627 on Jan. 8, 2004; and International Patent Application No. PCT/US2004/027912, filed Aug. 27, 2004, entitled “Electronic Control of Fluidic Species,” by Link, et al., each incorporated herein by reference. A schematic diagram of a microfluidic flow-focusing device 10 is illustrated in FIG. 1A. Briefly, a pressure gradient along the long axis of the device forced two substantially immiscible liquids into a narrow orifice as follows. A continuous liquid phase 12 (“B”) was supplied from side channels 11 of the device; a liquid stream 15 (“A”) was supplied from a center channel 14 (FIG. 1A). In this geometry, the continuous liquid phase 12 surrounded the inner liquid stream 15; of course, in other embodiments, other arrangements are also possible. The resulting inner liquid stream had an unstable cylindrical morphology, and broke up within orifice 13 in a generally periodic manner to release fluidic droplets 19 contained within continuous liquid phase 12 into outlet channel 18.

The microfluidic flow-focusing devices in this example were fabricated using poly(dimethylsiloxane) (“PDMS”) (Sylgard 184, Dow Corning, USA) and/or polyurethane (“PU”) elastomer (custom synthesized) using standard photolithographic procedures known to those of ordinary skill in the art. Photolithographic masters were prepared with features of SU-8 photoresist (MicroChem, USA) in bas-relief on silicon wafers. The height of the channels ranged from 25 micrometers to 200 micrometers and the orifice width ranged from 20 micrometers to 100 micrometers in the various devices that were fabricated. Liquids were supplied to the microfluidic devices via polyethylene tubing (Intramedic, USA, PE60, I.D. 0.76 mm, O.D. 1.22 mm) or polyethyleneterephthalate tubing (Hamilton, USA, I.D. 0.71 mm, 1.17 mm O.D.) attached to syringes operated by digitally-controlled syringe pumps (Harvard Apparatus, USA, PHD 2000 series). The flow of fluids to the microfluidic channels was controlled using independent syringe pumps. To ensure stable fluidic droplet formation, after any change in flow rates, the MFFD was equilibrated for at least 3 minutes.

The narrow size distribution of gaseous bubbles generated in the MFFD is believed to be a consequence of the controlled progression of the capillary instability. Due to viscous retardation in the confinement of the orifice, the velocity of collapse of the fluidic stream can be reduced, and may be controlled by controlling the rate of flow of the continuous liquid phase. This mechanism can also be used for liquid-liquid dispersions. This mechanism was further used to produce the narrow size distributions of the polymer and metal droplets produced upon solidification of the fluidic droplets, discussed in Example 2.

### EXAMPLE 2

The monodisperse droplets formed in the MFFD described in Example 1 were used to prepare particles in this example by solidifying these drops, either photochemically or thermally. FIG. 1B is a schematic diagram showing the polymerization of monomer droplets, and FIG. 1C is a schematic diagram showing the cooling of hydrogels or metals below their gelation or melting temperature, respectively. In these figures, the dashed rectangles 20 mark the position of the flow-focusing device shown in FIG. 1A. The channels used for photochemical cross-linking were also lengthened in this example to allow for generally longer durations of exposure of the droplets to UV light. This is shown in FIG. 1B as a “wavy” channel 5, eliminated by UV light source 27.

In various experiments, polymerization was used to produce monodisperse, solid, shaped particles from tripropyleneglycol diacrylate (“TPGDA”), dimethacrylate oxypropyldimethylsiloxane (“DMOS”), divinyl benzene (“DVB”), ethyleneglycol diacrylate, or pentaerythritol triacrylate in aqueous suspensions, using sodium dodecylsulfate (“SDS,” 2 wt %) as a surfactant. These monomers were mixed with a photoinitiator, 1-hydroxycyclohexyl phenyl ketone (4 wt %), then photopolymerized in a wavy channel (FIG. 1B) by illumination with UV light (400 W, 330 nm-380 nm wavelength). The polymerization time was controlled by controlling the flow rate of the liquid carrying the drops, and/or the length of the channel, and was found to be between 20 s and 800 s in these experiments. The conversion of monomer to polymer, as determined by the polymer gel fraction, was found to be close to 100%. The rate of particle production was as high as 250 particles/s in these experiments.

FIG. 2A shows a typical SEM image of spherical poly-TPGDA microsparticles polymerized in the MFFD; a colloidal crystal of these microsparticles is illustrated in FIG. 2B. The diameter of the microsparticles in these experiments was controlled to be between 20 micrometers and 200 micrometers; this diameter could be controlled, for example, by changing the rates of flow of the water phase and/or the geometry of the MFFD. Generally, the polymer microsparticles were found to be 3%-8% smaller than the corresponding fluidic droplets used to produce the particles, due to shrinkage during polymerization. The polydispersity (defined here as the standard deviation in the particle diameter, divided by the mean particle diameter) of the polymerized particles was found to be about 1.5%, and was also found to be similar to the polydispersity of the corresponding fluidic droplets.

The MFFD described in Example 1 was also used in some experiments to make particles by thermally-induced gelation or liquid-solid phase transition, by operating at a temperature within the fluid focusing orifice, T_{FF}, that was greater than the gelation or the liquid-solid phase transition temperature, T₀. In order to solidify droplets, the outlet channel was cooled to a temperature less than the liquid-solid phase transition temperature, T<T₀. For the thermal setting experiments, the flow-focusing region was kept at a temperature exceeding the gelling (or solid-liquid phase transition) temperature (T₀). Thus, the outlet channel 18 in FIG. 1A was cooled to a temperature below T₀, and the fluidic droplets solidified as they traveled down the outlet channel.

FIG. 1C shows a schematic of these systems. These systems were used to prepare particles from two materials: an aqueous solution of agarose (T₀=37° C.) and a low-melting-point bismuth alloy (T₀=47° C.). In both types of experiments, a continuous phase composed of a 3 wt % solution of surfactant, sorbitan monooleate (span 80) in hexadecane, was used. FIG. 2F illustrates agarose disks that were produced by this method. The width of the disks was pre-determined by the width and height of the channel (30 micrometers and 60 micrometers, respectively). By varying the flow rates of the continuous liquid phase and the liquid stream, disks were produced with diameters ranging from 50 micrometers to 250 micrometers, depending on the flow rates. The polydispersity of the disks did not exceed 3% in any of these experiments.

FIG. 2G shows bismuth alloy ellipsoids made in the MFFD geometry illustrated in FIG. 1C. The width and the height of the channel were each 60 micrometers. The mean width w of these ellipsoids was 58 micrometers (standard deviation σ_{w}=3.2% of w) and their length l was 94 micrometers (standard deviation σ₁=7.8%). The rate of making both agarose and solder particles was controlled by the flow rates applied to the system, and ranged in these experiments between 100 and 1000 particles/s.

Additional details of the experiments described in this example are as follows. High-gel strength agarose (EM Sciences, T₀=37° C., gel strength of a 1.5% solution>3200 g/cm²) and low melting bismuth alloy (T₀=47° C., composition: Bi (45%), Pb (23%), Sn (8%), Cd (5%), In (19%), Small Parts, USA, Part B-LMA-117) were used as received. With respect to the experiments involving agarose, solutions of high gel-strength agarose (2% w/w) were used in the liquid stream and a solution of span 80 surfactant (3% w/w) in hexadecane as the continuous liquid phase. With respect to the experiments involving solder, low melting point solder was used in the liquid stream and hexadecane as the continuous liquid phase. The temperature of the syringe and needle containing the agarose or solder reservoir was controlled, where required, with flexible heating tape (Omega, USA). In the thermal setting experiments using agarose, the delivery syringe/needle was heated to 85° C.; for solder, to 90° C. The temperature of the channels was controlled by placing the MFFD on Peltier plates (TE Technology, Inc., USA), and experiments were imaged through a Leica optical microscope (Leica, USA) connected to a Motic digital camera (Motic, USA).

In a typical experiment, a solution of agarose (3 wt %) was heated to 90° C. and introduced into a MFFD fabricated using PDMS at a flow rate of between 0.1 ml/h to 5 ml/h. All of the channels in the MFFD used in the thermal setting experiments had a uniform height that varied between 30 micrometers and 120 micrometers, depending on the MFFD; the width of the inlet channels was 150 micrometers for the side channels and 250 micrometers for the center channel. The width of the orifice varied between 30 micrometers and 60 micrometers, depending on the MFFD. The actual dimensions of the MFFD varied from the designed values by less than 3 micrometers. In the agarose experiments, a solution of span 80 in hexadecane (3 wt %) was introduced at a flow rate of 0.1 ml/h to 10 ml/h. The first half of the flow channel was heated to 90° C. on a Peltier plate; the second half of the flow channel was cooled to 20° C. on a second Peltier plate. The droplets generated at the orifice of the MFFD gelled as they traveled down the outlet channel. The MFFD produced particles at a frequency of about 1000 particles/s in these experiments.

TPGDA, DVB, EGD, pentaerythritol triacrylate, 1-hydroxycyclohexyl phenyl ketone, 4-cyano-4′-pentylbiphenyl, dioctyl phthalate, and SDS were purchased from Aldrich Canada and used as received. Dimethacrylate oxypropyldimethylsiloxane was purchased from Gelest (Gelest, USA) and used as received. Quantum dots were synthesized using previously reported techniques. The photopolymerization experiments were carried out in a MFFD fabricated in PU with a wavy channel to maximize the residence time of particles within the microfluidic channels. The particles were photopolymerized in the wavy channel using a UV lamp (UVAPRINT 40C/CE, Dr. K. Hönle GmbH UV-Technologie, Germany) with an output of 400 W at a wavelength of 330 nm to 380 nm. The experiments were imaged used an Olympus BX51 microscope (Olympus, USA) and a high-speed camera (Photometrics CoolSNAR ES). In a typical experiment, a 4 wt % mixture a 1-hydroxycyclohexyl phenyl ketone (photoinitiator) in a monomer was used to generate droplets in an aqueous solution of SDS (2 wt %) in the orifice of an MFFD. The polymerization time was controlled by the flow rate, and was typically between 20 s and 800 s. The MFFD produced particles at a frequency of ˜100 particles/s in these experiments.

In some experiments, it was shown that the MFFD could make up to 10⁵-10⁶ particles per hour. For example, increase throughput, several flow-focusing devices may be positioned on a single chip. For instance, greater than 10 devices may be positioned onto a single 2×3 inch substrate. Also, the use of a high-flux UV lamp may allow the length of the outlet channel required for polymerization to be decreased in some cases.

### EXAMPLE 3

In this example, non-spherical particles were produced using the MFFD described in Example 1. In some experiments, agarose disks and bismuth alloy ellipsoids were produced using methods similar to those described in Example 2, for example, by introducing a fluidic droplet having a volume such that the fluidic droplet, within the outlet channel, was not able to form a spherical shape, and instead, formed a non-spherical shape. For example, a rod, a disk, an ellipsoid, etc. Other examples of non-spherical particles are described in this example, and are illustrated in FIG. 2.

FIGS. 2A-2G are a series of optical microscopy images of polyTPGDA particles, some of which are non-spherical: microspheres (FIG. 2A), crystal of microspheres (FIG. 2B), rods (FIG. 2C), disks (FIG. 2D), and ellipsoids (FIG. 2E). Rods were prepared having aspect ratios as large as 1:12 FIG. 1C). The ellipsoid particles were formed at relatively high flow rates of the continuous phase in the wavy channel (e.g., the MFFD geometry illustrated in FIG. 1B). Also shown in FIG. 2 are optical microscope images of agarose disks (FIG. 2F) and bismuth alloy ellipsoids (FIG. 2G) produced using thermal solidification techniques. A monolayer of agarose disks is illustrated in FIG. 2F (shown in top view). The inset of FIG. 2G is a photo micrograph of the ellipsoids at higher magnification.

FIG. 3A shows the dependence of the droplet volume on the ratio of the flow rates of the aqueous phase to monomer phase, based on certain experiments. FIG. 3A is a log-log plot of the volume of the droplets versus the ratio of the rates of flow of the continuous and monomer phases: dimethacrylate oxypropyldimethylsiloxane (circles), divinyl benzene (triangles), and TPGDA (squares). The rate of flow of the monomer was 0.04 ml/h. Open symbols represent disks; filled symbols correspond to spheres. Droplets with a volume greater than 0.33×10⁻⁶ ml were found to be disk-shaped (open symbols). Increasing the ratio of flow rates to a value above 82 produced smaller, spherical droplets of DVB and TPGDA (filled symbols). FIGS. 3B-3D demonstrates the size distribution (diameters) of spheres, disks, and rods obtained from TPGDA, using a MFFD similar to the MFFD described in Example 1. The experimental points were fit with a Gaussian distribution. Droplet polydispersity in all cases was found to be less than 1.6% (i.e., 1.5% for spheres, 1.1% for disks, and 1.0% for rods). For disks or rods, the standard deviation σ of the diameter or length was divided by the mean values of the droplet diameter and length, respectively.

The volume V_{D} of spherical and non-spherical droplets produced in the orifice may be controlled by controlling the flow rates of the continuous and dispersed phases, which can be modeled as follows. The diameter of an undeformed, spherical droplet is given by d_{S}=(6V_{D}/π)^{1/3} (FIG. 1D). Non-spherical droplets can be formed when d_{S} is larger than at least one of the cross-sectional dimensions of the outlet channel. For instance, in wide channels, w>d_{S}, with height h<d_{S}, the drops can assume a discoid shape (FIG. 1E). In this figure, these disks have circular interfaces with the top and bottom walls of the channel. The diameter, d_{D}, of these interfaces can be set by the height of the channel and volume of the droplet. The liquid-liquid interfaces spanning the bottom and top walls of the outlet channel may be curved. For channels with relatively small aspect ratios (h/d_{D}), the droplets may have a cylindrical geometry, and the curvature at the liquid-liquid interface can be neglected such that the volume of these droplets can be estimated to be approximately d_{D}=2(V_{D}/πh)². If both the height and width of the channel are smaller than ds, the droplet may make contact with all of the channel walls, and may assume an ellipsoidal, or rod-like, morphology (FIG. 1F). A simple estimate of the length IR of elongated liquid plugs yields I_{R}=V_{D}/wh. The two aspect ratios (h/I_{R} and w/I_{R}) can be independently controlled, e.g., by changing the volume of the droplet and/or the ratio of the height to the width of the channel.

### EXAMPLE 4

This example illustrates the formation of multi-component and/or doped particles, including copolymer particles, fluorescent particles containing dyes or quantum dots, polymer-liquid crystals, and microporous particles. A MFFD was used to produce the particles in this example, similar to the MFFD described in Example 1.

In one set of experiments, microparticles containing carboxyl or amino groups (e.g., which may be useful for bioconjugation) were obtained by copolymerizing TPGDA with acrylic acid or vinyl imidazole, respectively. Fluorescent microspheres (FIG. 4A) were synthesized by copolymerizing methyl acrylate covalently attached to UV, visible, or near-IR dyes (NBD-dye, excitation wavelength of 488 nm) with TPGDA, or by polymerizing TPGDA admixed with 4 nm diameter CdSe quantum dots (excitation wavelength of 502 μm) (FIG. 4B).

Other types of hybrid microspheres were obtained in other experiments by polymerizing monomers mixed with metal or magnetic nanoparticles. For example, liquid crystal (“LC”)-polymer composite microparticles were synthesized by polymerizing TPGDA admixed with 4-cyano-4′-pentylbiphenyl (5 wt %-20 wt %) (FIG. 4C). When the polymerization was relatively fast, the LC mixed uniformly with the polyTPGDA; when relatively slow, the LC segregated into the core of the microsphere (FIG. 4C, inset, which is a polarization microscopy image of the 4-cyano-4′-pentylbiphenyl-polyTPGDA microspheres). In other experiments, porous microspheres were synthesized by mixing a porogen, dioctyl phthalate, with TPGDA (¼ wt. ratio), followed by polymerization, and subsequent removal of the porogen with acetone (FIG. 4D, which is a SEM image of a porous polyTPGDA microsphere). The average size of pores was about 0.90 micrometers in this experiment.

### EXAMPLE 5

This example describes a microfluidic axisymmetric flow focusing device (“AFFD”) fabricated in poly(dimethylsiloxane) that is able to produce polymer-coated droplets with size distributions significantly more narrow than those generated using conventional microencapsulation methods. The AFFD is able to confine droplets in the central axis of a microfluidic channel; this confinement protects droplets from shear, and/or from damage resulting from adhesion or wetting at the walls of the outlet channel. Avoiding contact of the droplets with the walls may also prevent the loss of control over flow rates associated with material wetting the walls of channels, or it may protect the nascent surface of the polymer film early in the interfacial polymerization reaction, when the film is fragile and contact with the wall may disrupt the membrane. These characteristics can allow the AFFD to produce microencapsulated droplets of liquids that are often difficult to obtain in quasi-two-dimensional microfluidic devices.

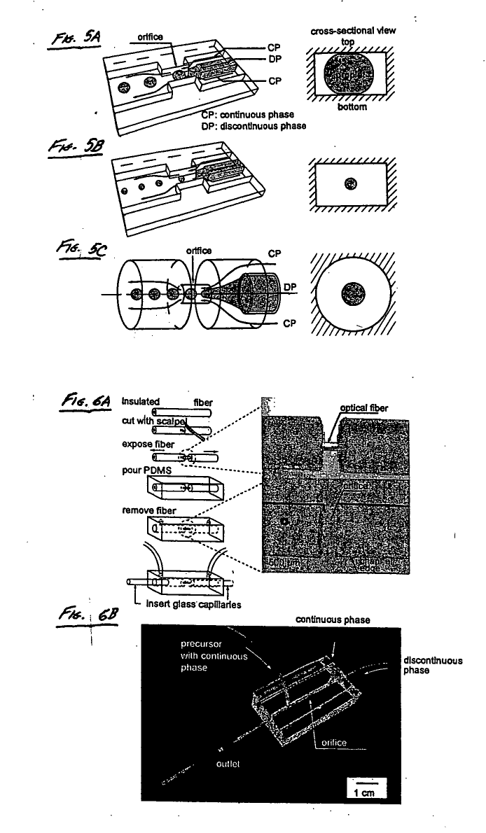

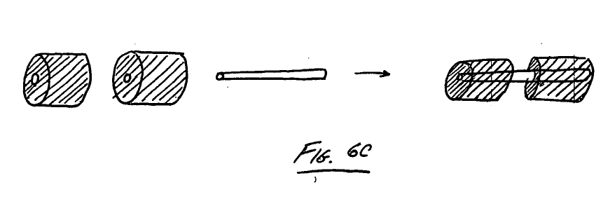

FIG. 6A illustrates the fabrication of the AFFD and FIG. 6B is an image of a device with two inserted glass capillaries serving as an inlet and outlet. An optical fiber 0.25 mm in diameter covered with a 0.75 mm thick layer of insulation was used as a master to create a channel, as follows. A section of the insulation on the optical fiber (0.25 mm in diameter covered with a 0.75 mm thick layer) was cut back using a scalpel and the ends pulled to expose a region of the optical fiber. The optical fiber was then molded in PDMS (3 cm×6 cm×1.5 cm), and after curing of the PDMS, the insulation and the optical fiber were removed from the PDMS by pulling the fiber and insulation out from one side, leaving the insulation on the other side intact. The insulation on the other side was then subsequently removed. Two glass capillaries (0.75 mm outer diameter, 0.5 mm inner diameter) were inserted as an inlet and outlet.

The narrow, central part of the channel created by the optical fiber mold served as the orifice; the size of the orifice can be reduced by using an optical fiber or insulated wire with a smaller diameter, or expanded by using an optical fiber or insulated wire with a larger diameter.

In the device illustrated in this example, the channel has three inlets and one outlet (see FIG. 6). An inlet for the discontinuous phase and an outlet for the droplets was formed by inserting glass capillaries (0.75 mm outer diameter, 0.5 mm inner diameter) into both sides of the orifice. The two inlets for the continuous phase were formed by drilling holes into the channel and connecting polyethylene tubing to the holes (FIG. 6B). In this configuration, three separate solutions could be introduced into the channel.

Additional details of the experiments in this example are now described. The channels were fabricated by embedding insulated optical fibers in PDMS (Sylgard 184, Dow Corning), as follows. Insulated optical fibers were prepared by inserting an optical fiber (Fiber optics SMF-28-09, Thorlabs Inc) into polyethylene tubing (PE90, Becton Dickinson and Company) that was filled with pre-epoxy (5 minute® Epoxy, Devcon). The use of polyethylene tubing as the insulating layer resulted in channels that were wide enough for the glass capillaries to be directly inserted, to serve as inlet/outlet channels. Holes for the inlets for the continuous phase were drilled with a needle (60_{1/2}, Becton Dickinson and Company), and polyethylene tubing (PE60) was inserted into the holes. Syringe pumps (PHD2000, Harvard Apparatus) were used to control the flow of fluids.

FIG. 5C illustrates certain details of the design of the AFFD. To prepare fluidic droplets in the AFFD, an aqueous solution of 1,6-diaminohexane (0.1 M) was delivered to the orifice from a capillary placed axisymmetrically in the flow tube. A solution of Span-80 (2% v/v) in hexadecane was used as the continuous phase. As the continuous phase flowed around the capillary, the aqueous phase formed a cylindrical thread that periodically entered the orifice, broke, and released droplets into the downstream portion of the flow tube (outlet channel). The break-up process was found to be stable, and the aqueous phase did not wet the walls of the channel, even at low flow rates. In FIG. 5C, which shows an axisymmetrical flow focusing channel (3D), the channel is composed of a cylindrical tube with a narrow cross-section. The narrow region serves as the orifice where fluid is focused and can be induced to break into separate droplets. In this geometry, the aqueous phase does not make contact with the walls. For comparison, FIG. 5A illustrates a conventional quasi-two-dimensional flow-focusing channel (2D). The discontinuous phase is broken into droplets by the continuous phase. A droplet usually contacts at least two (top and bottom) walls of the channels. In FIG. 5B, small droplets produced at high flow rates of the continuous phase may not experience shear stress with the walls; at these flow rates, leaking can be a problem in 2D channels.

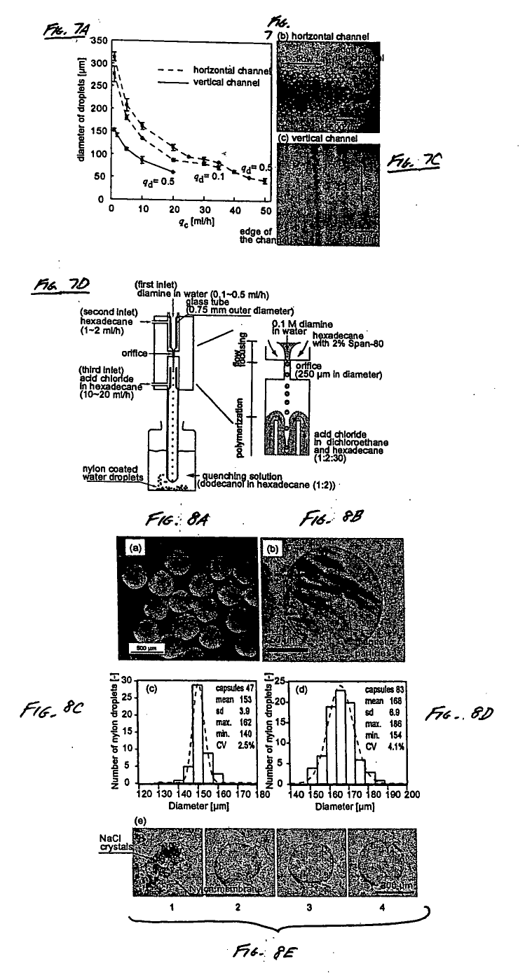

FIGS. 7A-7C illustrate variation in the size of the droplets formed in an AFFD positioned horizontally and vertically. Using a 250 micrometer diameter orifice, fluidic droplets 50-300 micrometers in diameter could be formed by varying the flow rate of the continuous phase between 1-50 mL/h. The diameter of the droplets was found to decrease as the flow rate of the continuous phase was increased. FIG. 7A shows the diameter of the droplets at the various flow rate of the continuous phase (q_{c}); q_{d} represents the flow rate of the discontinuous phase. The continuous phase was a solution of Span-80 in hexadecane (2% v/v). The discontinuous phase was an aqueous solution of 1,6-hexanediamine (0.1 M). FIGS. 7B and 7C are images showing droplets created in the AFFD oriented horizontally (FIG. 7B) and vertically (FIG. 7C) at flow rates of 10 mL/hr for both the continuous and discontinuous phases.

### EXAMPLE 6

This example illustrates the formation of droplets comprising nylon. In this example, a device similar to that described in Example 5 was used, except the device was oriented vertically, with flow from top to bottom. The size of droplets formed in a vertically-oriented AFFD were smaller than those formed at similar flow rates (of both phases) in a horizontal AFFD.

In a horizontally oriented device, the droplets in some cases accumulated on the wall of the outlet channel; accumulation caused the droplets to collapse during the early stage of the polymerization. In order to avoid this, the device was reoriented vertically. It was observed that the droplets followed the centerline of the channel and flowed one-by-one to the outlet.

Surprisingly, the size of droplets formed in a vertically oriented device were found to be smaller than those formed at the same flow rates (of both phases) in a device oriented horizontally. Gravity did not appear to have a major influence on the break-up process, as demonstrated by calculating the Bond (Bo) number, a dimensionless quantity that describes the relative importance of gravitational and interfacial forces. Bo was determined using the equation:
Bo=gΔρL²/γ,
where g is the gravitational acceleration (g≈9.8 m/s²), Δρ is the difference of densities of the aqueous and organic phase (ρ_{water}˜1 g/cm³, ρ_{hexadecane}˜0.77 g/cm³, Δρ≈3×10² kg/m³), and γ is the surface tension (γ≈3×10⁻² N/m). For a typical length scale, L, of the interface during break-up, the width of the orifice wₒᵣ was used (L=wₒᵣ≈10⁻⁴ m). In the device, a typical value of the Bond number was 10⁻³; this implied that gravity, and thus the orientation of the device, did not influence the process of break-up directly.

The orientation of the device, however, appeared to have some impact on the flow of the droplets in the outlet channel. These droplets were heavier than the continuous surrounding phase, and in a device oriented horizontally, the droplets settled against the floor on the channel where they formed a high volume fraction emulsion; the emulsion eventually filled the entire cross-section of the channel. This emulsion altered the flow of the continuous fluid, and provided a higher resistance to flow in the outlet channel, which may increase the pressure in the orifice region. By such a mechanism, gravity may indirectly influence the break-up process and lead to the difference in the size of droplets produced in devices oriented horizontally and vertically.

Also in this example, a vertical AFFD was used to prepare droplets coated with nylon-6,6 via the interfacial polymerization of adipoyl chloride in the continuous, hexadecane phase and 1,6-diaminohexane in the discontinuous, aqueous phase (FIG. 7D). FIG. 7D is a schematic diagram of the AFFD used to prepare nylon-6,6-coated aqueous droplets. An aqueous solution of 1,6-diaminohexane (0.1 M) was introduced into the channel at the first inlet. The continuous phase, Span-80 in hexadecane (2% v/v), was introduced into the channel from a second set of inlets. A solution of adipoyl chloride in dichloroethane and hexadecane (1:2:30) was introduced into the channel from a third capillary. Polymerization of adipoyl chloride and 1,6-diaminohexane occurred on the surface of droplets. A solution of dodecanol in hexadecane (30% v/v) was used to quench the polymerization reaction.

In this configuration, aqueous droplets suspended in the continuous phase (2% Span-80 in hexadecane) flowed into the outlet capillary together with a solution of adipoyl chloride in dichloroethane and hexadecane (1:2:30 v/v). When adipoyl chloride contacted the surface of the aqueous droplets, interfacial polymerization proceeded rapidly, and produced droplets coated with nylon-6,6. The outlet of the capillary was immersed in a beaker containing a solution of 1-dodecanol in hexadecane (30% v/v) that quenched unreacted adipoyl chloride, and terminated the polymerization reaction. In the absence of a quenching agent, the polymerization proceeded until all of the diamine had diffused out of the droplet; thus, the degree of polymerization within the droplet could be controlled as desired. By quenching the polymerization, droplets that were cross-linked as they came into contact in the collection beaker could be avoided or minimized. This quenching reaction may be useful, in some cases, to modify the properties of the membrane by including appropriate reactants in the quenching reaction.

### EXAMPLE 7

Using an experimental device similar to the one described in Example 6, in this example, nylon-6,6-coated aqueous droplets were produced (50-300 micrometers diameter) at a rate of about 500 droplets per minute; the process operated without blocking or interruption for greater than 6 hours (generating greater than 105 droplets). FIG. 8A shows photomicrographs of the microencapsulated droplets coated with nylon-6,6. The images of nylon-coated droplets were collected with CCD (DMX1200, Nikon) connected to a stereo- or inverted microscope. The diameter of droplets was measured by analyzing the images (Scion Image, Scion Corporation). Approximately 10% of the nylon-coated droplets collapsed or deformed during the polymerization. This may be induced by allowing the aggregation of the droplets during the polymerization step. Most of the remaining microcapsules (90%) were visually perfectly spherical, with a substantially uniform diameter.

FIGS. 8C and 8D illustrate the size distribution of the droplets as they were generated at the orifice, and after the nylon membrane had formed around the droplets. To determine the distribution, the diameter of the individual droplets produced at the orifice was measured, using encapsulated droplets that were neither deformed nor broken. The droplets were prepared in a vertically-oriented flow-focusing device using hexadecane as the continuous phase (flow-rate, 5 mL/h), and 1,6-diaminohexane as the discontinuous phase (flow-rate, 0.5 mL/h). The diameters of each droplet were measured using video analysis software (Scion Image). The error in measurements was approximately 5 micrometers (sd: standard deviation, CV: coefficient of variation). In this experiment, droplets that were deformed or collapsed (<10% of the droplets produced) were omitted. Although the deviation in the diameter of the droplets became slightly larger after polymerization (CV=4.1%) compared to that before (2.5%), it is small and on the order of the error of the measurement.

Using the AFFD in this example, the size of the droplets could be controlled to perform polymerization reactions on the surface of droplets. For example, micro- and nanoparticles were encapsulated inside nylon membranes by mixing the particles into the discontinuous phase. FIG. 8B illustrates a nylon-encapsulated droplet containing a ferrofluid (a superparamagnetic iron oxide particles approximately 50 nm in diameter stabilized with a surfactant), controlled within an external magnetic field. When an external magnetic field was applied, the magnetic particles inside the droplets aligned, and moved toward the magnetic field. The polymer membrane was relatively strong and did not break when the capsules were manipulated with the magnetic field. In this figure, the particles are aligned with respect to the magnetic field.

An interesting property of nylon membranes is their semipermeability. In some experiments, sodium chloride was added to the discontinuous phase (2%) to prepare salt solutions encapsulated in nylon-coated particles. When the droplets were dehydrated using ethanol, the nylon surfaces collapsed and the collapsed capsules appeared filled with crystals of sodium chloride. When the particles were re-suspended in water, the osmotic pressure across the nylon surfaces caused them to expand and fill with water, until they again formed spherical particles; remarkably, the nylon membranes did not break during collapse and subsequent swelling. FIG. 8E illustrates a sequence of images in time depicting the hydration of a particle having a nylon-6,6 surface, and containing sodium chloride crystals. The resulting nylon membranes were filled with crystals of sodium chloride (Frame 1). The solvent was exchanged for water, and the membrane was imaged over time as it swelled. The total time lapsed between Frames 1 and 4 is approximately 30 seconds. In Frame 4, the membrane is fully swelled and appears spherical. The scale bar in Frame 4 is 300 micrometers. The hydration of salt crystal within the permeable membrane produced polymer-coated particles with few defects. This phenomenon may be a useful model for studying “osmophoresis,” i.e., the osmotic motion of cells or small capsules in concentration gradients.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A collection of articles comprising a plurality of particles, at least some of which are non-spherical; and/or comprise a metal and/or a magnetizable material and/or a nylon and/or a ferrofluid; and/or at least some of which particles have a ratio of a largest dimension to a smallest dimension that is less than about 5; and/or at least some of which particles have a porosity of at least about 0.1; and/or at least some of which particles are microparticles having a core and a shell, the shell comprising a semi-permeable portion and/or a polymer made by a process comprising urging a fluid comprising a polymer precursor into a microfluidic channel, and hardening the polymer precursor in the channel to form the polymer; wherein the particles have an average dimension of less than about 500 micrometers and a distribution of dimensions such that no more than about 5% of the particles have a dimension greater than about 10% of the average dimension.

2. The collection of articles of claim 1, wherein at least some of the particles each have a shape that is one of rod shaped, disk shaped or ellipsoid shaped.

3. The collection of articles of claim 1, made by a process comprising urging a fluidic droplet defining a precursor of one of the particles into a microfluidic channel and hardening the particle in the channel.

4. The collection of articles of claim 1, wherein at least some of the particles comprise one or more metals, at least one of which is selected from the group consisting of lead, cadmium, tin, indium, zinc, antimony, copper, silver, gold, gallium, bismuth, or iron.

5. The collection of articles of claim 1, wherein no more than about 5%, about 3%, about 1%, about 0.1%, or about 0.1% of the particles have a dimension greater than about 5%, about 3%, about 1%, about 0.1%, or about 0.01% of the average dimension.

6. The collection of articles of claim 1, wherein the droplets have an average dimension of less than about 100 micrometers, about 50 micrometers, about 40 micrometers, about 25 micrometers, about 10 micrometers, about 5 micrometers, about 1 micrometer, about 0.3 micrometers, about 0.1 micrometers, or about 0.01 micrometers.

7. The collection of articles of claim 1, wherein at least some of the particles have a porosity of at least about 0.2, about 0.3, or about 0.4.

8. The collection of articles of claim 1, wherein the ferrofluid comprises an iron oxide.

9. A method, comprising an act of:
solidifying at least a portion of a plurality of fluidic droplets, at least some of which comprise a metal and/or a magnetizable material and/or a nylon and/or a ferrofluid, wherein the fluidic droplets have an average dimension of less than about 500 micrometers and a distribution of dimensions such that no more than about 5% of the droplets have a dimension greater than about 10% of the average dimension.

10. A collection of articles comprising a plurality of particles, at least some of which are made using the method of claim 9.

11. The method of claim 9, comprising cooling at least some of the fluidic droplets to a temperature sufficient to cause the fluidic droplets to at least partially solidify.

12. The method of claim 1, wherein at least some of the fluid droplets comprise one or more metals, at least one of which is selected from the group consisting of lead, cadmium, tin, indium, zinc, antimony, copper, silver, gold, gallium, bismuth, or iron.

13. The method of claim 9, wherein no more than about 5%, about 3%, about 1%, about 0.1%, or about 0.1% of the fluidic droplets have a dimension greater than about 5%, about 3%, about 1%, about 0.1%, or about 0.01% of the average dimension.

14. The method of claim 9, wherein the fluidic droplets have an average dimension of about 100 micrometers, about 50 micrometers, about 40 micrometers, about 25 micrometers, about 10 micrometers, about 5 micrometers, about 1 micrometer, about 0.3 micrometers, about 0.1 micrometers, or about 0.01 micrometers.

15. The method of claim 9, comprising solidifying at least some of the fluidic droplets to form non-spherical particles.

16. The method of claim 9, wherein the ferrofluid comprises an iron oxide.

17. A method, comprising acts of:
urging a fluidic droplet into a microfluidic channel having a smallest cross-section dimension that is smaller than the diameter of a perfect mathematical sphere having a volume of the droplet; and
solidifying the fluidic droplet within the channel to form a non-spherical particle.

18. A collection of articles comprising a plurality of particles, at least some of which are made using the method of claim 17.

19. The method of claim 17, wherein the channel has a largest cross-sectional dimension that is less than about 500 micrometers, about 100 micrometers, about 50 micrometers, about 10 micrometers, about 5 micrometers, or about 1 micrometer.

20. The method of claim 17, wherein the fluidic droplet comprises a metal.

21. The method of claim 17, wherein the fluidic droplet comprises one or more metals, at least one of which is selected from the group consisting of lead, cadmium, tin, indium, zinc, antimony, copper, silver, gold, gallium, bismuth, or iron.

22. The method of claim 17, comprising cooling the fluidic droplet to a temperature sufficient to cause the fluidic droplet to at least partially solidify.

23. The method of claim 17, comprising solidifying the fluidic droplet into a non-spherical shape.

24. The method of claim 17, wherein the particle has a ratio of a largest dimension to a smallest dimension that is less than about 5.

25. The method of claim 17, wherein the fluidic droplet has a volume greater than about 1 nl, about 3 nl, about 10 nl, about 30 nl, about 100 nl, about 300 nl, or about 1000 nl.

26. The method of claim 17, comprising urging a plurality of fluidic droplets into the microfluidic channel, and solidifying the plurality of fluidic droplets to form a plurality of particles having an average dimension of less than about 500 micrometers, about 100 micrometers, about 50 micrometers, about 40 micrometers, about 25 micrometers, about 10 micrometers, about 5 micrometers, about 1 micrometer, about 0.3 micrometers, about 0.1 micrometers, or about 0.01 micrometers and a distribution of dimensions such that no more than about 5%, about 3%, about 1%, about 0.1%, or about 0.1% of the particles have a dimension greater than about 10%, about 5%, about 3%, about 1%, about 0.1%, or about 0.01% of the average dimension.

27. A method, comprising an act of:
exposing at least a portion of a plurality of particles to an agent able to remove at least a portion of the particles, wherein the particles have an average dimension of less than about 500 micrometers, about 100 micrometers, about 50 micrometers, about 40 micrometers, about 25 micrometers, about 10 micrometers, about 5 micrometers, about 1 micrometer, about 0.3 micrometers, about 0.1 micrometers, or about 0.01 micrometers and a distribution of dimensions such that no more than about 5%, about 3%, about 1%, about 0.1%, or about 0.1% of the particles have a dimension greater than about 10%, about 3%, about 1%, about 0.1%, or about 0.01% of the average dimension.

28. The method of claim 27, wherein the agent is able to dissolve at least some of the particles.

29. The method of claim 27, wherein the agent comprises an organic solvent.

30. The method of claim 27, wherein the agent comprises acetone.

31. The method of claim 27, wherein the agent comprises a porogen.

32. The method of claim 27, wherein the agent comprises dioctyl phthalate.

33. The method of claim 27, wherein at least some of the particles, after exposure to the agent, are porous.

34. The method of claim 27, comprising removing a portion of at least some of the particles such that the particles become non-spherical.

35. A method, comprising an act of:
hardening a polymeric material around a sectioned optical fiber.

36. The method of claim 35, wherein the optical fiber is concentrically sectioned.

37. The method of claim 35, wherein the optical fiber is incapable of transmitting light.

38. The method of claim 35, further comprising removing the sectioned optical fiber.

39. The method of claim 35, wherein the polymeric material is elastomeric.

40. The method of claim 35, wherein the polymeric material comprises poly(dimethylsiloxane).

41. An article made by the method of claim 35.

42. A collection of articles comprising a plurality of particles, at least some of which are microparticles having a core and a shell, the shell comprising a nylon.
